(19) United States
(12) Patent Application Publication
(10) Pub. No.: US 2014/0195211 A1
(43) Pub. Date: Jul. 10, 2014

(54) TOPOGRAPHY SIMULATION APPARATUS, TOPOGRAPHY SIMULATION METHOD AND RECORDING MEDIUM

(71) Applicant: KABUSHIKI KAISHA TOSHIBA, Tokyo (JP)

(72) Inventor: Takashi ICHIKAWA, Saitama-shi (JP)

(21) Appl. No.: 14/020,667

(22) Filed: Sep. 6, 2013

(30) Foreign Application Priority Data
Jan. 9, 2013 (JP) 2013-001549

(51) Int. Cl. G06F 17/50

(52) U.S. Cl. CPC G06F 17/5009
USPC 703/2

(57) ABSTRACT

In one embodiment, a topography simulation apparatus includes a division module to divide a substance surface into plural computing elements, a determination module to extend straight lines in plural directions from each computing element, and to determine whether each straight line contacts the substance surface and determine which computing element each straight line contacts, and a calculation module to calculate, based on results of the determinations, a direct flux of a reactive species directly reaching each computing element, and a form factor indicating a positional relationship between the computing elements. When the determinations are performed to calculate the form factor in a case where an ionic species reaching each computing element is reflected, the determinations are performed by setting a cut-off angle for a reflection direction of the ionic species, and limiting the directions in which the straight lines are extended within a range of the cut-off angle.

### CROSS REFERENCE TO RELATED APPLICATION

This application is based upon and claims the benefit of priority from the prior Japanese Patent Application No. 2013-001549, filed on Jan. 9, 2013, the entire contents of which are incorporated herein by reference.

### FIELD

Embodiments described herein relate to a topography simulation apparatus, a topography simulation method and a recording medium.

### BACKGROUND

When a surface of a substance is processed by chemical vapor deposition (CVD), reactive ion etching (RIE) or the like, a simulation of topography of the processed surface is an important technique. In this simulation, the surface of the substance is generally divided into computing elements to calculate a flux of a reactive species reaching each computing element and a local surface grow rate of the substance. However, long calculation time is required to consistently calculate the flux and the surface growth rate on the entire surface. This is because the calculation time increases with the square order of the number of the computing elements. On the other hand, reactive species are classified into an ionic species which has high straightness and is anisotropically incident, and a neutral species which has low straightness and is isotropically incident. However, since conventional simulations are carried out without considering the difference between these reactive species, a waste and an error are caused in the calculation.

### BRIEF DESCRIPTION OF THE DRAWINGS

FIG. 1 is a flowchart illustrating a procedure of a topography simulation method of a first embodiment;

FIG. 2 is a perspective view illustrating an example of an initial structure of a substance of the first embodiment;

FIG. 3 is a schematic diagram for illustrating a level set function;

FIG. 4 is a flowchart illustrating details of step S3 in FIG. 1;

FIG. 5 is a schematic diagram illustrating a substance surface divided into computing elements;

FIG. 6 is a schematic diagram for explaining a difference in straightness between an ionic species and a neutral species;

FIG. 7 is a diagram for explaining a cut-off angle for a reflection direction of the ionic species;

FIG. 8 is a flowchart illustrating details of steps S12 and S13 in FIG. 4;

FIGS. 9A and 9B are diagrams for explaining a local coordinate system;

FIG. 10 is a schematic diagram for explaining a visibility determination value;

FIG. 11 is a schematic diagram for explaining a visibility factor;

FIG. 12 is a schematic diagram for explaining an incident angle θᵢₙ;

FIG. 13 is a schematic diagram for explaining a mirror surface boundary condition;

FIG. 14 is a schematic diagram for explaining a periodic boundary condition;

FIG. 15 is a schematic diagram for explaining a two-dimensional computing element visibility determination value;

FIG. 16 is a schematic diagram for explaining a three-dimensional computing element visibility determination value;

FIG. 17 is a flowchart illustrating details of step S14 of FIG. 4;

FIGS. 18A to 18D are schematic diagrams for illustrating a process of FIG. 17;

FIG. 19 is another schematic diagram for illustrating the process of FIG. 17;

FIG. 20 is another schematic diagram for illustrating the process of FIG. 17;

FIG. 21 is a graph illustrating an example of calculation time in a comparative example;

FIG. 22 is a graph illustrating an example of calculation time in the first embodiment;

FIG. 23 is a graph illustrating a comparison between the calculation time of the first embodiment and the comparative example;

FIG. 24 is a graph illustrating a relation between a “θ” division number and calculation errors in the first embodiment and the comparative example;

FIG. 25 is a graph illustrating a comparison between the calculation time of the first embodiment and the comparative example when only the ionic species is treated;

FIG. 26 is a graph illustrating a comparison between the calculation time of the first embodiment and the comparative example when the ionic species and the neutral species are treated;

FIG. 27 is a graph illustrating a comparison between the calculation time of the first embodiment and the comparative example for each item when only the ionic species is treated;

FIG. 28 is a graph illustrating a comparison between the calculation time of the first embodiment and the comparative example for each item when the ionic species and the neutral species are treated;

FIG. 29 is an outline view illustrating a configuration of a topography simulation apparatus of a second embodiment; and

FIG. 30 is a block diagram illustrating a configuration of a control module of FIG. 29.

### DETAILED DESCRIPTION

Embodiments will now be explained with reference to the accompanying drawings. In the drawings, identical or similar components are denoted by identical reference numerals, and a redundant description thereof is omitted as needed.

In one embodiment, a topography simulation apparatus includes a division module configured to divide a surface of a substance into a plurality of computing elements. The apparatus further includes a determination module configured to extend straight lines in a plurality of directions from each computing element, and configured to determine whether each straight line contacts the surface of the substance and determine which computing element each straight line contacts. The apparatus further includes a calculation module configured to calculate, based on results of the determinations, a direct flux which is a flux of a reactive species directly reaching each computing element, and a form factor indicating a positional relationship between the computing elements. When the determinations are performed to calculate the form factor in a case where an ionic species reaching each computing element is reflected, the determination module performs the determinations by setting a cut-off angle for a reflection direction of the ionic species, and limiting the directions in which the straight lines are extended within a range of the cut-off angle. When a straight line from a first computing element among the plurality of computing elements contacts a second computing element, the determination module judges whether a straight line from the first computing element contacts a third computing element surrounding the second computing element, and judges whether the third computing element is positioned within the range of the cut-off angle of the first computing element. The determination module selects, as the third computing element, a computing element directly adjacent to the second computing element, and a computing element indirectly adjacent to the second computing element through one or more computing elements each having positive results of the judgments, and repeats the judgments until there is no candidate for the third computing element to be selected.

### First Embodiment

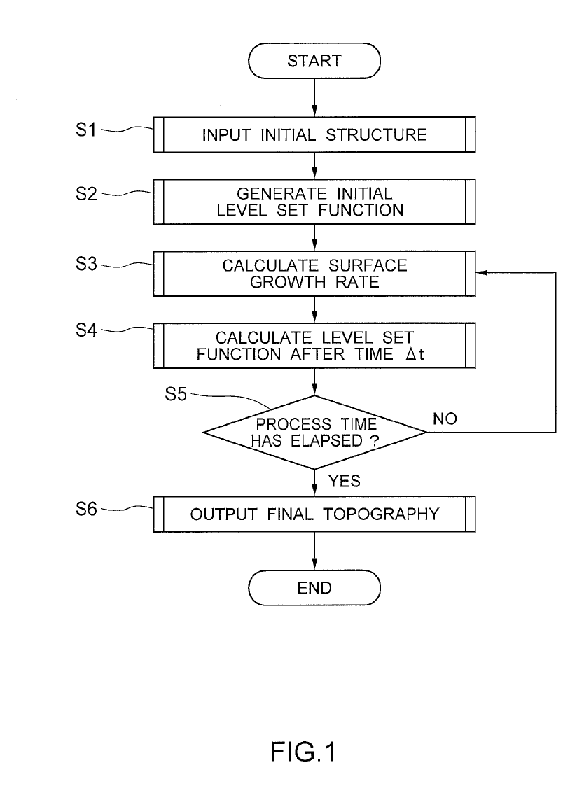

FIG. 1 is a flowchart illustrating a procedure of a topography simulation method of a first embodiment. The topography simulation method of this embodiment is carried out using an information processing apparatus such as a personal computer or a work station.

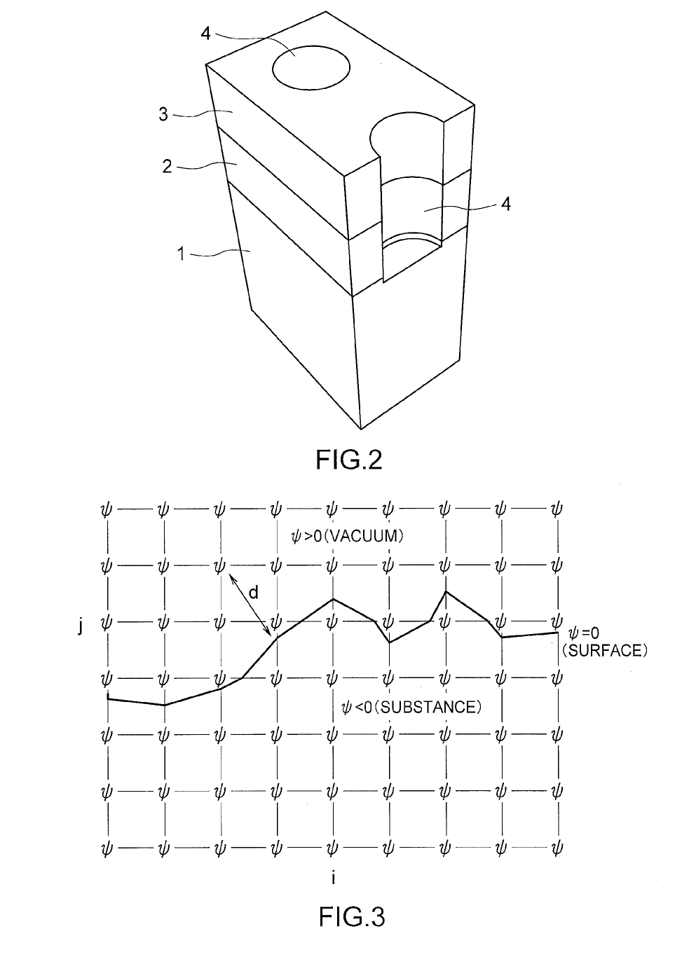

In the topography simulation method of this embodiment, an initial structure of a substance is inputted to an information processing apparatus (step S1). FIG. 2 is a perspective view illustrating an example of the initial structure of the substance of the first embodiment. The initial structure illustrated in FIG. 2 includes a silicon substrate 1, a silicon nitride film 2 and a silicon oxide film 3 formed in this order on the silicon substrate 1, and through holes 4 penetrating the silicon nitride film 2 and the silicon oxide film 3. Various formats may be used as examples of the method of inputting the initial structure. In this embodiment, however, a method is employed in which the topography of a substance surface is expressed by a sequence of points to be read by the information processing apparatus.

Next, an initial level set function is generated from the inputted initial structure (step S2). FIG. 3 is a schematic diagram for illustrating a level set function. A level set function φ is a function defined using a distance “d” from the surface of the substance, and has a value for each mesh within a calculating area. The value of the level set function φ is defined as 0 at the surface of the substance (φ=0). Further, φ>0 holds at the outside of the substance (in vacuum), and φ<0 holds at the inside of the substance (in the substance). In the case of generating the initial level set function, a surface closest to each mesh point is searched, and the distance “d” is calculated. Further, when a mesh point is in vacuum, a positive sign is set, and when the mesh point is within the substance, a negative sign is set. The initial level set function may be inputted in step S1, instead of being generated in step S2.

Next, a local surface growth rate “F” of the substance is calculated (step S3). It is assumed herein that the surface growth includes not only deposition on the surface but also etching of the surface. There is no need to calculate the surface growth rate “F” for each time step. In this embodiment, as described later, the surface growth rate “F” is calculated from the flux (total flux) on the surface of the substance, and the level set function from the surface growth rate “F” is calculated. Alternatively, the level set function from the flux may be calculated, and the calculation of the surface growth rate “F” may be omitted.

Next, the level set function after a lapse of a time Δt is calculated using the surface growth rate “F” (step S4). The level set function φₜ at a time t can be calculated from the following formula (1).

φₜ+F|∇φₜ|=0 (1)

where ∇ represents a vector differential operator, |∇φₜ| represents a norm of ∇φₜ. The level set function after a lapse of the time Δt allows calculation by performing time evolution on the level set function in accordance with a formula obtained by discretizing the formula (1). In this embodiment, the surface growth rate “F” and the flux in a certain surface topography may be calculated, instead of performing time evolution on the surface topography. This corresponds to the case where step S5 described later is determined as Yes in a first step.

Next, it is determined whether a preset process time has elapsed or not (step S5). When the process time is ended, the final topography of the substance is output (step S6), and the calculation ends. When the process time is not ended, the process returns to step S3.

In this embodiment, a level set method is employed as a technique for expressing the topography, but techniques, such as a cell method and a string method, other than the level set method may be employed.

### (1) Details of Step S3

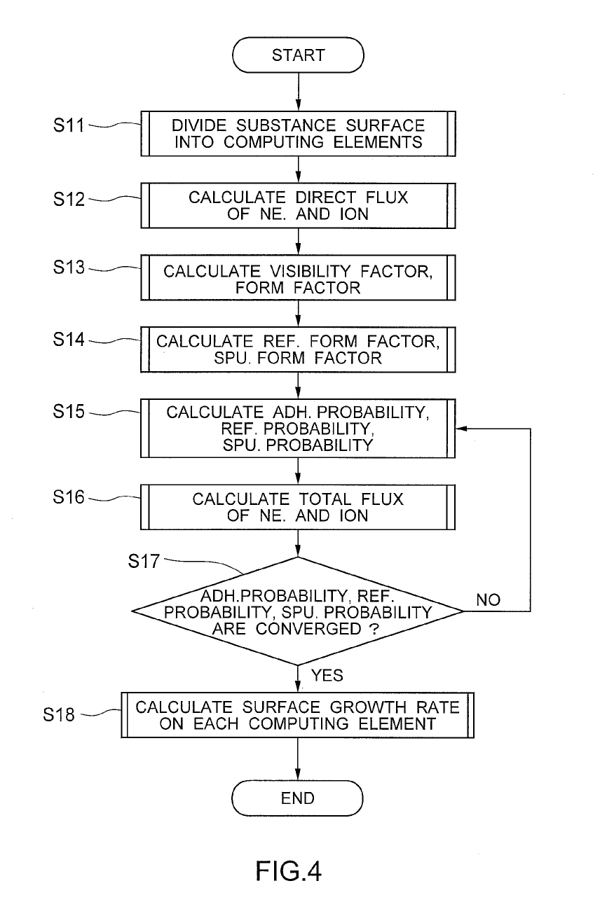

Referring to FIG. 4, step S3 will be described in detail.

FIG. 4 is a flowchart illustrating details of step S3 in FIG. 1.

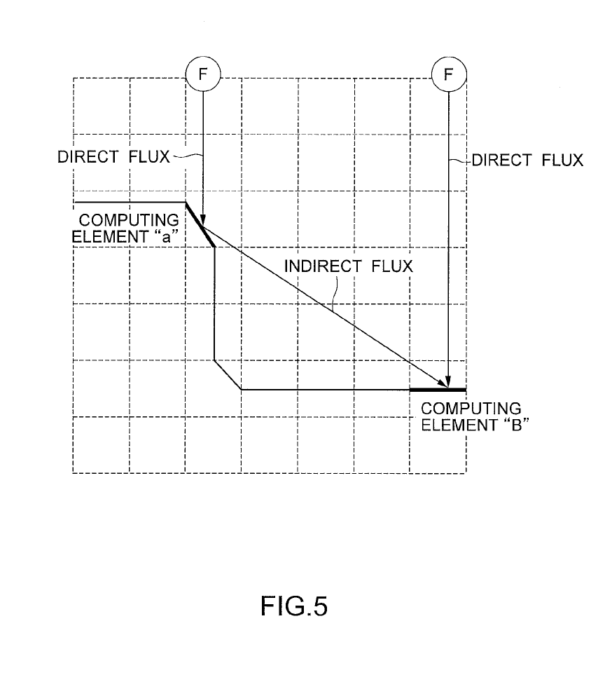

First, the substance surface represented by the level set method is divided into a plurality of computing elements (step S11). FIG. 5 is a schematic diagram illustrating the substance surface divided into computing elements. In the example of FIG. 5, the substance surface is divided for each mesh. As a result, the substance surface within one mesh is one computing element. A block that performs the process of step S11 is an example of a division module of the disclosure.

The method of dividing the substance surface is not limited to the unit of mesh, but any method may be employed. The division of the substance surface is not necessarily performed for each time step, but may be performed immediately after step S1, for example.

Though the calculation area illustrated in FIG. 5 is a two-dimensional area, a three-dimensional area may be used instead. The shape of each computer element illustrated in FIG. 5 is a line segment, but a point, a polygon, or the like may be used instead.

FIG. 5 illustrates a first computing element “a” and a second computing element “B”. In the case of calculating the flux of the reactive species reaching the computing element “B”, the flux of the reactive species directly reaching the computing element “B” from a gas space, and the flux of the reactive species indirectly reaching the computing element “B” through any computing element “a” from the gas space are generally taken into consideration. The former flux is referred to as a direct flux, and the latter flux is referred to as an indirect flux. The sum of these fluxes is referred to as a total flux. Examples of the reactive species include a deposition species and an etching species.

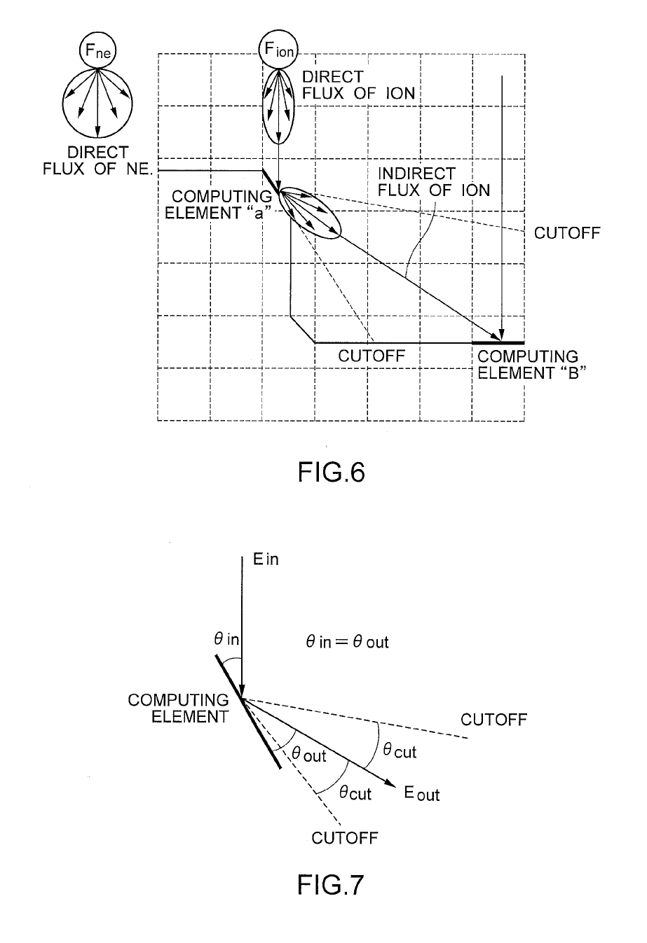

The reactive species are classified into an ionic species which has high straightness and is anisotropically incident, and a neutral species which has low straightness and is isotropically incident. FIG. 6 is a schematic diagram for explaining a difference in straightness between the ionic species and the neutral species.

FIG. 6 illustrates a state where the ionic species incident on the computing element “a” is reflected. As illustrated in FIG. 6, the ionic species has high straightness and is not reflected in all directions. Accordingly, in the case of calculating the indirect flux of the ionic species, it is desirable to set a cut-off angle for a reflection direction of the ionic species to ignore the reflection to the outside of the range of the cut-off angle. As a result, it is possible in this embodiment to reduce a waste of calculation to shorten the calculation time, and to reduce calculation errors by taking more time for useful calculation instead of useless calculation, thereby enabling high-speed, high-precision topography simulation.

FIG. 7 is a diagram for explaining the cut-off angle for the reflection direction of the ionic species. Reference symbols Eᵢₙ and θᵢₙ respectively denote the incident direction and the incident angle of the perpendicularly incident ionic species. Reference symbols Eₒᵤₜ and θₒᵤₜ respectively denote the reflection direction and the reflection angle when the perpendicularly incident ionic species is specularly reflected. A relation of θᵢₙ=θₒᵤₜ is established between the incident angle θᵢₙ and the reflection angle θₒᵤₜ.

As illustrated in FIG. 7, a cut-off angle θ_{cut} is set around the reflection direction Eₒᵤₜ, and it is assumed that the ionic species is not reflected to the outside of the range of the cut-off angle θ_{cut} in this embodiment. The topography simulation using the cut-off angle θ_{cut} will be described in detail later.

Hereinafter, a total flux Γ_{B,ne} of the neutral species and a total flux Γ_{B,ion} of the ionic species in the computing element “B” will be described.

The total flux _{B,ne} of the neutral species in the computing element “B” is represented by the sum of a direct flux Γ_{B,ne-direct} of the neutral species in the computing element “B” and an indirect flux Γ_{aB,ne-indirect} of the neutral species from any computing element “a” as shown in the following formula (2).

$${Γ}_{B , ne} = {Γ}_{B , ne \text{-} direct} + {\sum }_{a = 1}^{A} {Γ}_{aB , ne \text{-} indirect} \qquad ( 2 )$$

Similarly, the total flux Γ_{B,ion} of the ionic species in the computing element “B” is represented by the sum of a direct flux Γ_{B,ion-direct} in the computing element “B” and the total of an indirect flux Γ_{aB,ion-indirect} of the ionic species from any computing element “a” as shown in the following formula (3).

$${Γ}_{B , ion} = {Γ}_{B , ion \text{-} direct} + {\sum }_{a = 1}^{A} {Γ}_{aB , ion \text{-} indirect} \qquad ( 3 )$$

Here, the indirect fluxes Γ_{aB,ne-indirect} and Γ_{aB,ion-indirect} can be respectively represented by, for example, the following formulas (4) and (5).

Γ_{aB,ne-indirect}=(1−Sₐ(Γ_{a,ion},Γ_{a,ne}))ν(a,B)g(a,B)Γ_{a,ne}+Pₐ(Γ_{a,ion},Γ_{a,ne})ν(a,B)g_{ionS}(a,B)Γ_{a,ionS}(a,B)Γ_{a,ion} (4)

Γ_{aB,ion-indirect}=Rₐ(Γ_{a,ion},Γ_{a,ne}))ν(a,B)g_{ionR}(a,B)Γ_{a,ion} (5)

Sₐ(Γ_{a,ion}, Γ_{a,ne}) represents an adhesion probability indicating a ratio of the flux of neutral species absorbed by each computing element “a”. Rₐ(Γ_{a,ion}, Γ_{a,ne}) represents a reflection probability indicating a ratio of the flux of ionic species reflected by each computing element “a”. Pₐ(Γ_{a,ion}, Γ_{a,ne}) represents a sputtering probability indicating a ratio at which the substance surface is etched by sputtering using the flux of ionic species to generate the flux of neutral species in each computing element “a”. The values of Sₐ(Γ_{a,ion}, Γ_{a,ne}), Rₐ(Γ_{a,ion}, Γ_{a,ne}) and Pₐ(Γ_{a,ion}, Γ_{a,ne}) depend on the total flux Γ_{a,ion} of the ionic species and the total flux Γ_{a,ne} of the neutral species in each computing element “a”.

Further, ν(a, B) represents a visibility factor (face-to-face visibility factor) indicating whether the computing element “a” and the computing element “B” are visible to each other. When the straight line connecting the computing elements “a” and “B” contact the substance surface, ν=0 holds. When the straight line does not contact the substance surface, ν=1 holds.

Further, g(a, B) represents a form factor illustrating a positional relationship (face relation) between the computing element “a” and the computing element “B”. The value of g(a, B) represents a degree at which the computing elements “a” and “B” are visible to each other. The value of g(a, B) depends on the distance and angle between the computing elements “a” and “B”.

In the case of treating the reflection of ionic species and sputtering using ionic species, the form factor “g” also depends on the straightness and scattering of ionic species. Therefore, in addition to the form factor “g”, a form factor (reflection form factor) g_{ionR} for reflection of the ionic species and a form factor (sputtering form factor) g_{ionS} for sputtering using ionic species are introduced in this embodiment.

g_{ionR}(a,B) represents a form factor between the computing element “a” and the computing element “B” when the ionic species reaching the computing element “a” is reflected. g_{ionS}(a,B) represents a form factor between the computing element “a” and the computing element “B” when the neutral species is generated by sputtering using the ionic species reaching the computing element “a”. On the other hand, g(a,B) represents a form factor between the computing element “a” and the computing element “B” when the neutral species reaching the computing element “a” is scattered again from the computing element “a”. Examples of the case where the neutral species is scattered again include a case where the absorbed neutral species is discharged and a case where the neutral species is reflected.

When the formula (4) and the formula (5) are respectively substituted into the formula (2) and the formula (3), the total fluxes Γ_{a,ion} and Γ_{a,ne} in the computing element “B” can be represented by the following formulas (6) and (7), respectively.

$$\begin{matrix}{Γ}_{B , ne} = {Γ}_{B , ne \text{-} direct} + {\sum }_{a = 1}^{A} \{ ( 1 - {S}_{a} ( {Γ}_{a , ion} , {Γ}_{a , ne} ) ) v ( a , B ) g ( a , B ) {Γ}_{a , ne} + {P}_{a} ( {Γ}_{a , ion} , {Γ}_{a , ne} ) v ( a , B ) {g}_{ionS} ( a , B ) {Γ}_{a , ion} \} & ( 6 ) \\ {Γ}_{B , ion} = {Γ}_{B , ion \text{-} direct} + {\sum }_{a = 1}^{A} {R}_{a} ( {Γ}_{a , ion} , {Γ}_{a , ne} ) ) v ( a , B ) {g}_{ionR} ( a , B ) {Γ}_{a , ion} & ( 7 )\end{matrix}$$

Next, in the flow of FIG. 4, the direct fluxes Γ_{B,ne-direct} and Γ_{B,ion-direct} in arbitrary computing elements and the visibility factor ν, the form factor g, the reflection form factor g_{ionR}, and the sputtering form factor g_{ionS} between arbitrary computing elements are calculated (steps S12 to S14).

Next, the direct fluxes Γ_{i,ne-direct} and Γ_{i,ion-direct} of each computing element “i” are respectively used as temporal total fluxes Γ_{i,ne} and Γ_{i,ion}, and the adhesion probability Sᵢ(Γ_{i,ion}, Γ_{i,ne}), the reflection probability Rᵢ(Γ_{i,ion}, Γ_{i,ne}) and the sputtering probability Pᵢ(Γ_{i,ion}, Γ_{i,ne}) in each computing element “i” are calculated (step S15).

Next, the total fluxes Γ_{i,ion} and Γ_{i,ne} in each computing element “i” are respectively calculated from the following formulas (8) and (9) by using the visibility factor ν, the form factors g, g_{ionR} and g_{ionS}, the direct fluxes Γ_{i,ne-direct} and Γ_{i,ion-direct}, the adhesion probability Sᵢ(Γ_{i,ion}, Γ_{i,ne}), the reflection probability Rᵢ(Γ_{i,ion}, Γ_{i,ne}), and the sputtering probability Pᵢ(Γ_{i,ion}, Γ_{i,ne}) (step S16).

$$\begin{matrix}{Γ}_{i , ne \text{-} direct} = {Γ}_{i , ne} - {\sum }_{a = 1}^{A} \{ ( 1 - {S}_{a} ( {Γ}_{a , ion} , {Γ}_{a , ne} ) ) v ( a , B ) g ( a , B ) {Γ}_{a , ne} + {P}_{a} ( {Γ}_{a , ion} , {Γ}_{a , ne} ) v ( a , B ) {g}_{ionS} ( a , B ) {Γ}_{a , ion} \} & ( 8 ) \\ {Γ}_{i , ion \text{-} direct} = {Γ}_{i , ion} - {\sum }_{a = 1}^{A} {R}_{a} ( {Γ}_{a , ion} , {Γ}_{a , ne} ) ) v ( a , B ) {g}_{ionR} ( a , B ) {Γ}_{a , ion} & ( 9 )\end{matrix}$$

Next, the processes of step S15 and step S16 are repeated until the values of the adhesion probability Sᵢ(Γ_{i,ion}, Γ_{i,ne}), the reflection probability Rᵢ(Γ_{i,ion}, Γ_{i,ne}), and the sputtering probability Pᵢ(Γ_{i,ion}, Γ_{i,ne}) are converged (step S17). In the second and subsequent step S15, the total fluxes Γ_{i,ion} and Γ_{i,ne} calculated in the previous step S16 are used as the temporal total fluxes Γ_{i,ion} and Γ_{i,ne}, respectively. In step S17, it is determined whether the values of Sᵢ(Γ_{i,ion}, Γ_{i,ne}), Rᵢ(Γ_{i,ion}, Γ_{i,ne}), and Pᵢ(Γ_{i,ion}, Γ_{i,ne}) are converged or not based on whether a change in Sᵢ(Γ_{i,ion}, Γ_{i,ne}), Rᵢ(Γ_{i,ion}, Γ_{i,ne}), and Pᵢ(Γ_{i,ion}, Γ_{i,ne}) is equal to or smaller than a threshold. The total fluxes Γ_{i,ion} and Γ_{i,ne} obtained when the values of these probabilities Sᵢ(Γ_{i,ion}, Γ_{i,ne}), Rᵢ(Γ_{i,ion}, Γ_{i,ne}) and Pᵢ(Γ_{i,ion}, Γ_{i,ne}) are converged are treated as correct calculation results of the total fluxes Γ_{i,ion} and Γ_{i,ne}.

When the number of computing elements is “N”, the visibility factor ν and the form factors g, g_{ionR}, and g_{ionS} between arbitrary computing elements can be collectively represented as N×N matrix. The visibility factor ν and the form factors g_{ionR}, and g_{ionS}, which are represented in a matrix form, are respectively referred to as a visibility factor matrix and a form factor matrix. The flux in any computing element can be represented by an N-row vector. The flux represented by a vector form is referred to as a flux vector.

In this case, the formula (8) can be expressed by a matrix equation as in the following formula (10).

$$\begin{matrix}{A}_{ne} {\vec{Γ}}_{i , ne} = {\vec{Γ}}_{i , ne \text{-} direct} & ( 10 ) \\ {\vec{Γ}}_{i , ne} = [ \begin{matrix}{Γ}_{1 , ne} \\ {Γ}_{2 , ne} \\ ⋮ \\ {Γ}_{i , ne} \\ ⋮ \\ {Γ}_{I , ne}\end{matrix} ] & ( 11 ) \\ {\vec{Γ}}_{i , ne \text{-} direct} = [ \begin{matrix}{Γ}_{1 , ne \text{-} direct} \\ {Γ}_{2 , ne \text{-} direct} \\ ⋮ \\ {Γ}_{i , ne \text{-} direct} \\ ⋮ \\ {Γ}_{I , ne \text{-} direct}\end{matrix} ] & ( 12 ) \\ {A}_{ne} = [ \begin{matrix}1 + ( {S}_{1} ( {Γ}_{1} ) - 1 ) v ( 1 , 1 ) g ( 1 , 1 ) & ( {S}_{2} ( {Γ}_{2} ) - 1 ) v ( 1 , 2 ) g ( 1 , 2 ) & ⋯ & ( {S}_{j} ( {Γ}_{j} ) - 1 ) v ( 1 , j ) g ( 1 , j ) & … & ( {S}_{J} ( {Γ}_{J} ) - 1 ) v ( 1 , J ) g ( 1 , J ) \\ ( {S}_{1} ( {Γ}_{1} ) - 1 ) v ( 2 , 1 ) g ( 2 , 1 ) & 1 + ( {S}_{2} ( {Γ}_{2} ) - 1 ) v ( 2 , 2 ) g ( 2 , 2 ) & … & ( {S}_{j} ( {Γ}_{j} ) - 1 ) v ( 2 , j ) g ( 2 , j ) & … & ( {S}_{J} ( {Γ}_{J} ) - 1 ) v ( 2 , J ) g ( 2 , J ) \\ ⋮ & ⋮ & ⋱ & ⋮ & … & ⋮ \\ ( {S}_{1} ( {Γ}_{1} ) - 1 ) v ( i , 1 ) g ( i , 1 ) & ( {S}_{2} ( {Γ}_{2} ) - 1 ) v ( i , 2 ) g ( i , 2 ) & … & 1 + ( {S}_{j} ( {Γ}_{j} ) - 1 ) v ( i , j ) g ( i , j ) & … & ( {S}_{J} ( {Γ}_{J} ) - 1 ) v ( i , J ) g ( i , J ) \\ ⋮ & ⋮ & ⋮ & ⋮ & ⋱ & ⋮ \\ ( {S}_{1} ( {Γ}_{1} ) - 1 ) v ( I , 1 ) g ( I , 1 ) & ( {S}_{2} ( {Γ}_{2} ) - 1 ) v ( I , 2 ) g ( I , 2 ) & … & ( {S}_{j} ( {Γ}_{j} ) - 1 ) v ( I , j ) g ( I , j ) & … & 1 + ( {S}_{J} ( {Γ}_{J} ) - 1 ) v ( I , J ) g ( I , J )\end{matrix} ] & ( 13 )\end{matrix}$$

where “I”, “J” represents the number of computing elements to be processed, and I=J=N holds, for example. In the formula (13), for convenience of notation space, the adhesion probability Sⱼ(Γ_{j,ion}, Γ_{j,ne}) is abbreviated as Sⱼ(Γⱼ) and terms including the sputtering probability Pᵢ)Γ_{i,ion}, Γ_{i,ne}) are omitted.

The matrix equation (10) may be solved by any solution. Examples of the solution include an iterative method (Gauss-Seidel iteration method, SOR method, Jacobi method, conjugate gradient method, etc.), and a direct method (Gaussian elimination, LU decomposition, Cholesky decomposition etc.). In the case of solving the matrix equation (10), when the matrix Aₙₑ is a sparse matrix, memory saving and speed-up of the calculation process may be achieved by using a routine suitable for the sparse matrix using a storage method such as CRS.

The formula (9) can also be represented by a matrix equation similar to that of the formula (8). In this embodiment, these two matrix equations can be solved by the above-mentioned solution.

Next, in the flow of FIG. 4, a local surface growth rate Γᵢ in each computing element “i” is calculated from the total fluxes Γ_{i,ion} and Γ_{i,ne} (step S18). For example, in the case of using “κ” types of reactive species, the surface growth rate Γᵢ is modeled in the form of the following formula (14) depending on “κ” local total fluxes Γ_{1,i} to Γ_{K,i}.

Fᵢ=f(Γ_{i,j}, . . . , Γ_{k,i}, . . . , Γ_{K,i}) (14)

where “k” is any real number that satisfies 1≦k≦K. The “κ” types of reactive species may include only one of neutral species and ionic species, or may include both neutral species and ionic species. As described above, the process of step S3 is ended.

### (2) Details of Steps S12 and S13

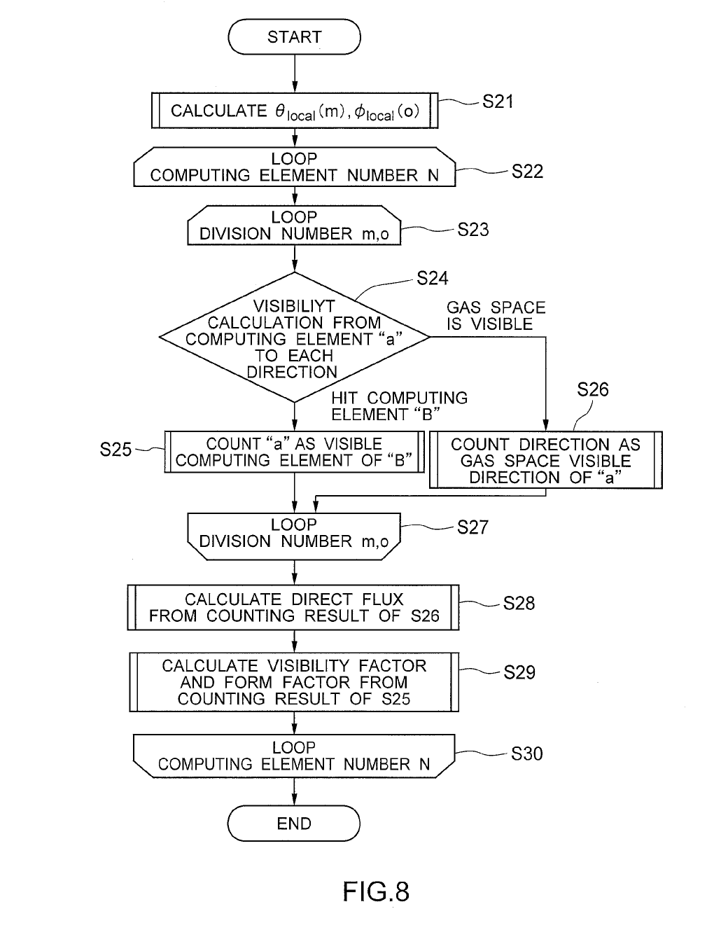

Referring to FIG. 8, steps S12 and S13 will be described in detail.

In steps S12 and S13, the direct flux Γ_{B,ne-direct} of the neutral species, and the direct flux Γ_{B,ion-direct}, the visibility factor ν, and the form factor “g” of the ionic species are calculated. In this case, the direct flux Γ_{B,ne-direct} of the neutral species and the direct flux Γ_{B,ion-direct} of the ionic species are calculated by the same method. In the following description, methods for calculating the direct flux Γ_{B,ne-direct} the visibility factor ν, and the form factor “g” of the neutral species will be described, and the description of the method of calculating the direct flux Γ_{B,ion-direct} of the ionic species is omitted. For convenience of description, the direct flux Γ_{B,ne-direct} of the neutral species is simply referred to as a direct flux Γ_{B,direct}.

FIG. 8 is a flowchart illustrating details of steps S12 and S13 in FIG. 4.

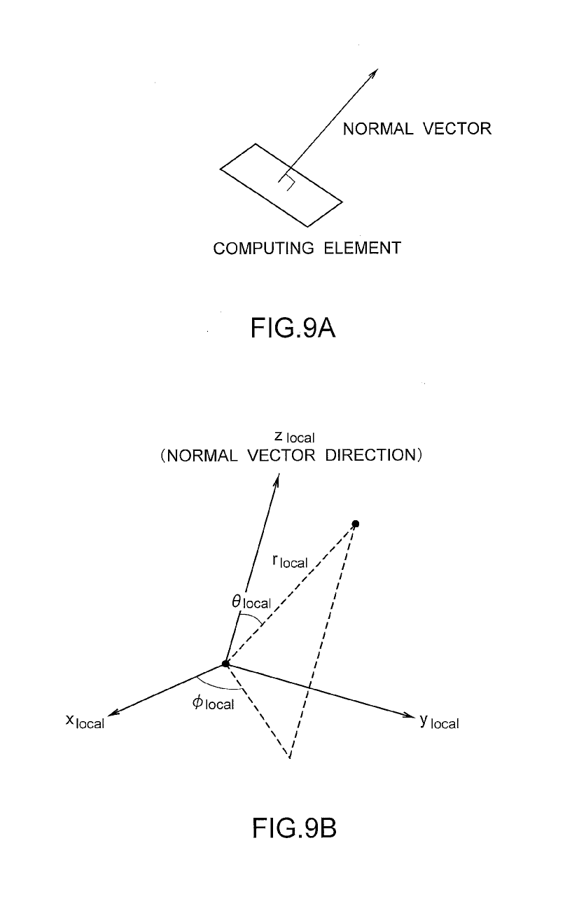

In the flow of FIG. 8, a local coordinate system unique to each computing element is used. FIGS. 9A and 9B are diagrams for explaining a local coordinate system. FIG. 9A illustrates a normal vector of each computing element, and FIG. 9B illustrates a local coordinate system in each computing element. As illustrated in FIG. 9B, the orthogonal coordinates (x_{local}, y_{local}, z_{local}) of the local coordinate system are determined such that a +z_{local} direction coincides with a normal vector direction. The polar coordinates (r_{local}, θ_{local}, φ_{local}) of the local coordinate system is determined such that the zenith angle θ_{local} becomes an angle between the radius vector r_{local} and the +Z_{local} direction and that the azimuth angle φ_{local} becomes an angle between the radius vector r_{local} and the +x_{local} direction.

The direct flux Γ_{B,direct} in the computing element “B” is calculated by the following formula (15).

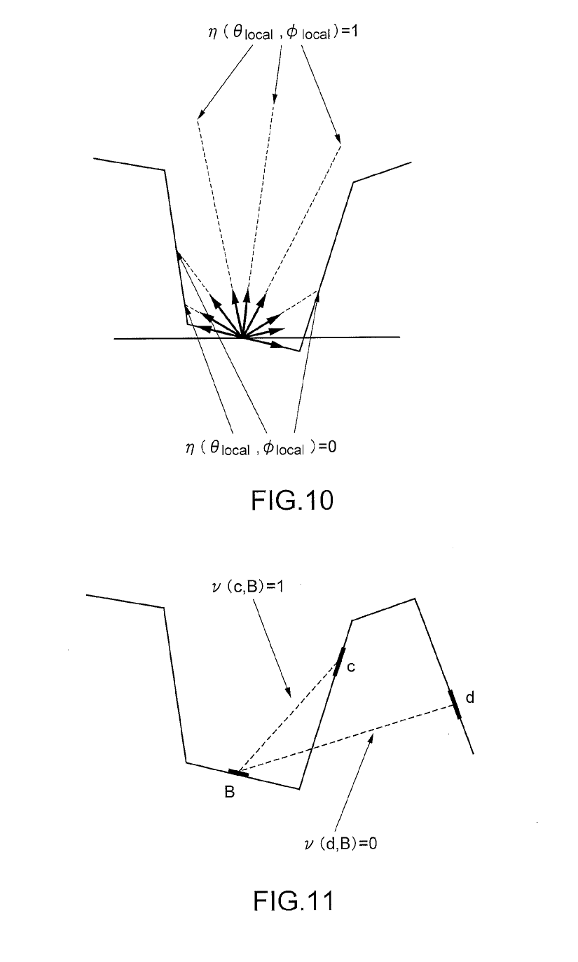

Γ_{B,direct}=f_{flat}Norm∫₀^{2π}∫₀^{π}η(θ_{local},φ_{local})f(θ_{local})|sin θ_{local}|dθ_{local}dφ_{local} (15)

where η(θ_{local}, φ_{local}) represents a visibility determination result when a straight line is extended in the directions of θ_{local} and φ_{local} from the computing element “B”, and is referred to as a visibility determination value. FIG. 10 is a schematic diagram for explaining the visibility determination value η. As illustrated in FIG. 10, when the straight line contacts the substance surface, η=0 holds. When the straight line does not contact the substance surface, η=1 holds. As illustrated in FIG. 10, when the straight line is extended only in the direction on one side of the substance surface, the integral range of θ_{local} in the formula (15) is from 0 to π, or may be from 0 to π/2.

As to the difference between the visibility determination value η and the visibility factor ν, see FIG. 11. FIG. 11 is a schematic diagram for explaining the visibility factor ν. Here, η(a, B) indicates whether the computing element a and the computing element B are visible to each other. When the straight line connecting the computing elements “a” and “B” contacts the substance surface between the computing elements “a” and “B”, ν=0 holds. When the straight line does not contact the substance surface, ν=1. See a computing element “d” as an example of the former case, and see a computing element “c” as an example of the latter case.

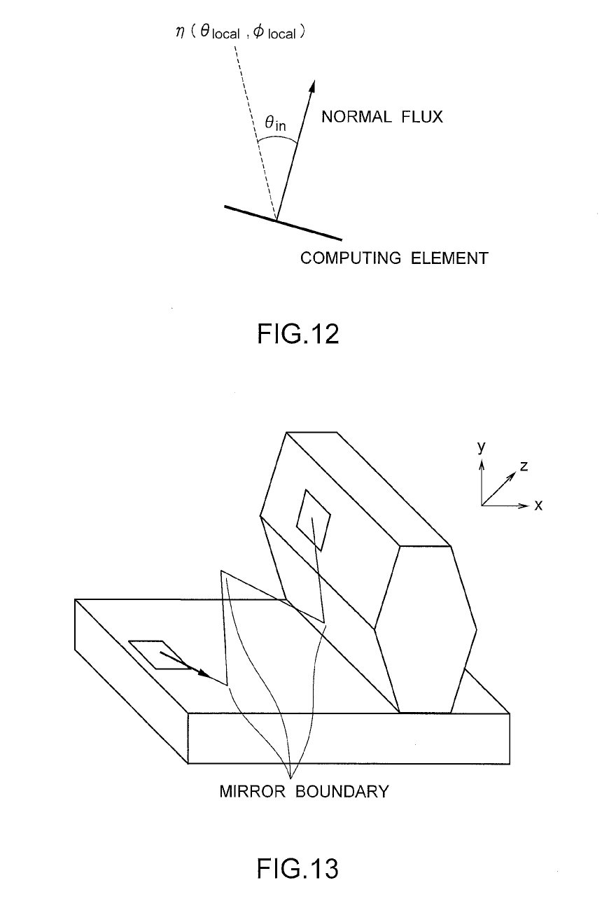

Further, f_{flat} represents a direct flux at a flat surface, and is given in advance as an input value, Norm represents a normalization constant given by the following formula (16), and f(θ_{local}) represents a factor of an area fragment of a direct flux, and is given by the following formula (17), for example.

$$\begin{matrix}Norm = \frac{N + 1}{2 π} & ( 16 ) \\ f ( {θ}_{local} ) = {cos}^{N - 1} {θ}_{local} cos {θ}_{in} & ( 17 )\end{matrix}$$

where θᵢₙ represents an incident angle as illustrated in FIG. 12. FIG. 12 is a schematic diagram for explaining the incident angle θᵢₙ. The incident angle θᵢₙ corresponds to the angle between the normal vector direction and the θ_{local} and φ_{local} directions. Accordingly, in the case of using the local coordinate system (r_{local}, θ_{local}, φ_{local}), θᵢₙ=θ_{local} holds.

The flow of FIG. 8 will be described in detail below.

First, the value of the sequence θ_{local}(m) of the zenith angle θ_{ocal} (m=0, 1, . . . , M−1), and the value of the sequence θ_{local}(o) of the azimuth angle φ_{local} (o=0, 1, . . . , O−1) are calculated (step S21). This corresponds to division of the range of the zenith angle θ_{local} from 0 to π into “M” areas and division of the range of the azimuth angle φ_{local} from 0 to 2π into “O” areas. As described later, the integral calculation of the formula (15) is discretized using the sequences θ_{local}(m) and φ_{local}(o).

In the case of using the area fragment factor illustrated in the formula (17) is used for the calculation of the direct flux Γ_{B,direct} of the formula (15), the sequences θ_{local}(m) and φ_{local}(o) as represented by the following formulas (18) and (19) are prepared.

$$\begin{matrix}{θ}_{local} ( m ) = {cos}^{- 1} ( {( 1 - \partial ( m ) )}^{\frac{1}{N + 1}} ) & ( 18 ) \\ {φ}_{local} ( o ) = \frac{2 π ( o + 0.5 )}{O} & ( 19 )\end{matrix}$$

where the sequence ∂(m) is given by the following formula (20).

$$\partial ( m ) = \frac{m + 0.5}{M} \qquad ( 20 )$$

where θ_{local}(m) of the formula (18) represents an angle at which the integral result becomes ∂(m) when f(θ_{local})|sin θ_{local}| is integrated from θ_{local}=0 to θ_{local}=θ_{local}(m). The relation of the formula (21) is established from the definition, and the formula (22) is deduced from the formula (21) and is transformed to thereby obtain the formula (18).

∂(m)=[−cos^{N+1}θ_{local}]₀^{θ}^{_{local}}^{(m)} (21)

∂(m)=1−cos^{N+1}θ_{local}(m) (22)

As described above, in step S21, the range of the zenith angle θ_{local} from 0 to π is divided at irregular intervals, and the range of the azimuth angle φ_{local} from 0 to 2π is divided at regular intervals. In this embodiment, not only the range of the zenith angle θ_{local}, but also the range of the azimuth angle φ_{local} may be divided at irregular intervals. When the integral range of the zenith angle θ_{local} is set from 0 to π/2, the range of the zenith angle θ_{local} not from 0 to π but from 0 to π/2 may be divided into “M” areas.

Next, straight lines are extended in a plurality of directions from each computing element “a”, and it is determined whether each straight line contacts the substance surface, and determined which computing element each straight line contacts (step S24). The directions in which the straight lines are extended from each computing element “a” is determined by the sequences θ_{local}(m) and φ_{local}(o) in each computing element “a”. Specifically, in step S24, the straight lines are extended in the directions of θ_{local}(m) and φ_{local}(o) from each computing element “a”. Accordingly, M×O straight lines are extended from each computing element “a”. The process of step S24 is performed for each of the “N” computing elements “a”. A block that performs the process of step S24 is an example of a determination module of the disclosure.

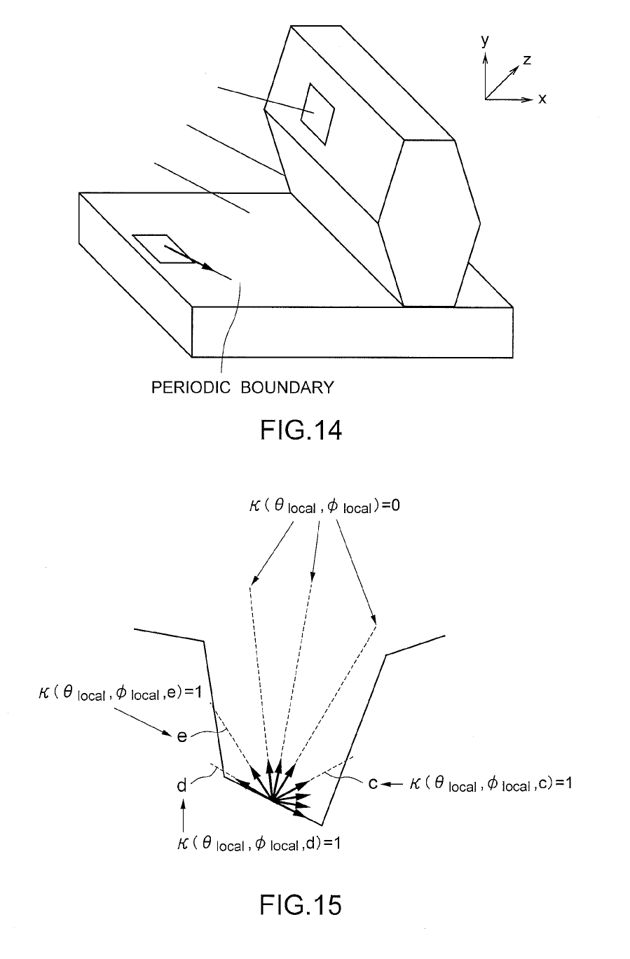

In step S24, the visibility determination may be performed in consideration of a mirror surface boundary condition and a periodic boundary condition. FIGS. 13 and 14 are schematic diagrams for explaining the mirror surface boundary condition and the periodic boundary condition, respectively. Such a determination makes it possible to perform flux calculation incorporating the boundary condition at low cost.

As described above, in step S24, it is determined whether each straight line from a plurality of computing elements “a” contacts the substance surface, and determined which computing element each straight line contacts. The process of step S25 is performed for the straight line that contacts the substance surface, and the process of step S26 is performed for the straight line that does not contact the substance surface.

In step S25, when any straight line from a computing element “a” contacts the computing element “B”, the computing element “a” is counted as a visible computing element of the computing element “B”. On the other hand, when no straight line from a computing element “a” contacts the computing element B, the computing element “a” is not counted as the visible computing element of the computing element “B”. Such a process is performed on all the computing elements “a”, thereby specifying all the computing elements “a” that are visible from the computing element “B”. This process is not limited to the computing element B, but is performed on all the “N” computing elements in a similar manner.

On the other hand, in step S26, when a straight line from a computing element “a” does not contact the substance surface (i.e., reaches the gas space), the direction of the straight line is counted as a gas space visible direction of the computing element “a”. Such a process is performed on all straight lines, thereby specifying all the directions in which the reactive species directly reaches each computing element “a” from the gas space. This specification result can be used for calculation of the direct flux. For example, the counting result of the gas space visible direction of the computing element “B” is used for the calculation of the direct flux in the computing element “B”.

In the flow of FIG. 8, the direct flux Γ_{B,direct} in the computing element “B” is then calculated by using the counting result of step S26 (step S28). The direct flux Γ_{B,direct} is expressed as the following formula (23) by discretizing the formula (15) using the sequences θ_{local}(m) and φ_{local}(o).

$${Γ}_{B , direct} = \frac{{f}_{flat}}{M \times O} {\sum }_{m}^{M} {\sum }_{o}^{O} η ( {θ}_{Blocal} ( m ) , {φ}_{Blocal} ( o ) ) \qquad ( 23 )$$

where θ_{Blocal}(m) and φ_{Blocal}(o) respectively represent sequences θ_{local}(m) and φ_{local}(o) in the computing element “B”. Further, η(θ_{Blocal}, φ_{Blocal}) in the formula (23) is represented by η=1 in the gas space visible direction of the computing element “B”, and is represented by η=0 in the other directions. Accordingly, the formula (23) can be calculated by using the gas space visible direction of the computing element B counted in step S26.

In the flow of FIG. 8, a visibility factor ν(a, B) between the computing elements “a” and “B” and a form factor g(a, B) are then calculated by using the counting result of step S25 (step S29). The form factor g(a, B) can be expressed as the following formula (24) using the sequences θ_{Blocal}(m) and φ_{Blocal}(o).

$$g ( a , B ) = \frac{1}{M \times O} {\sum }_{m}^{M} {\sum }_{o}^{O} κ ( {θ}_{Blocal} ( m ) , {φ}_{Blocal} ( o ) , a ) \qquad ( 24 )$$

where κ(θ_{Blocal}, φ_{Blocal}, a) represents a result of visibility determination as to whether each computing element “a” is visible in the directions of θ_{Blocal} and φ_{Blocal} from the computing element “B”, and is referred to as a computing element visibility determination value. When the computing element “a” is visible in the directions of θ_{Blocal} and φ_{Blocal} from the computing element “B”, κ(θ_{Blocal}, φ_{Blocal}, a)=1 holds. When the computing element “a” is invisible, κ(θ_{Blocal}, φ_{Blocal}, a)=0 holds. Accordingly, the formula (24) can be calculated in consideration of whether the computing element “a” is counted as the visible computing element of the computing element “B” in step S25.

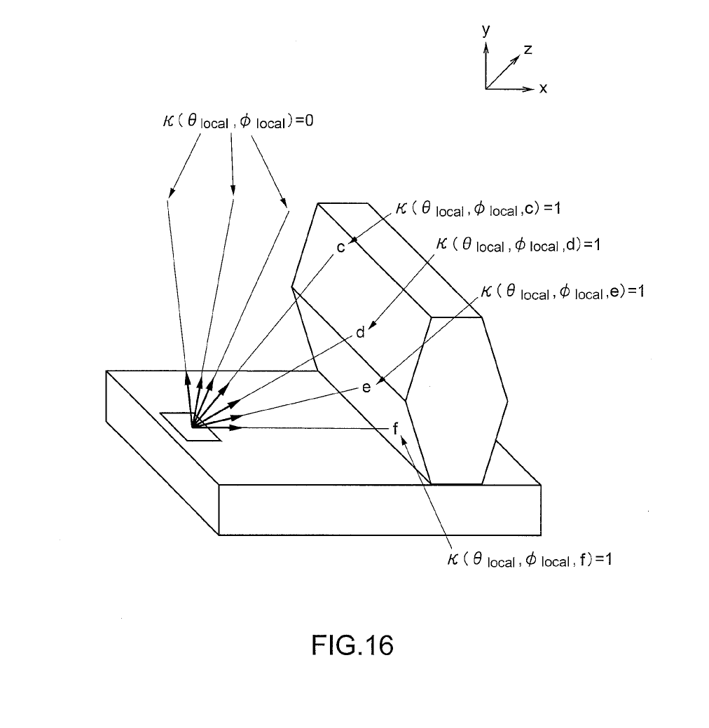

Examples of calculating the computing element visibility determination value “κ” two-dimensionally and three-dimensionally are respectively illustrated in FIGS. 15 and 16. FIGS. 15 and 16 are schematic diagrams for explaining the two-dimensional and three-dimensional computing element visibility determination values “κ”, respectively.

The visibility factor ν(a, B) can be calculated from the calculation result of g(a, B) obtained by the formula (24). Specifically, when g(a, B)=0, ν(a, B)=0 holds, and when g(a, B)>0, ν(a, B)=1 holds.

As described above, in steps S28 and S29, the direct flux Γ_{B,direct}, the visibility factor ν(a, B), and the form factor g(a, B) are calculated based on the determination result of step S24. Blocks that perform the processes of steps S28 and S29 are examples of a calculation module of the disclosure. In step S28, both the direct flux Γ_{B,ne-direct} of the neutral species and the direct flux Γ_{B,ion-direct} of the ionic species are calculated.

The calculation results of Γ_{B,ne-direct}, Γ_{B,ion-direct}, ν(a,B), and g(a,B) obtained in the flow of FIG. 8 are used for calculation of the total fluxes Γ_{B,ion} and Γ_{B,ne}, the surface growth rate Γᵢ, the level set function ψₜ, and the like in the flows of FIGS. 1 and 4. Blocks that calculate these values are also examples of the calculation module of the disclosure.

### (3) Details of Step S14

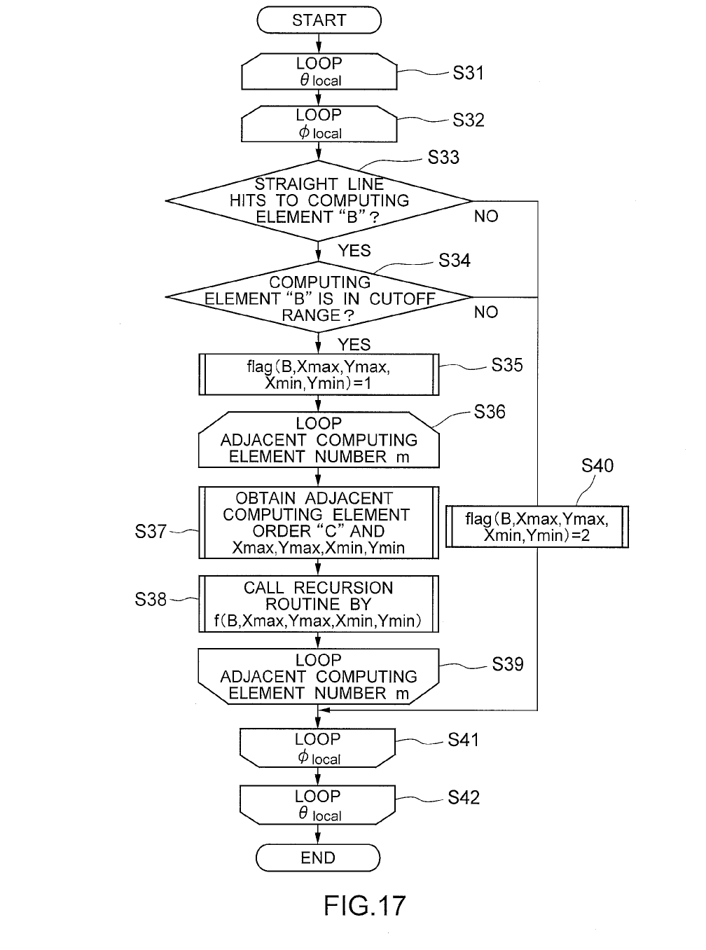

Referring to FIG. 17, step S14 will be described in detail.

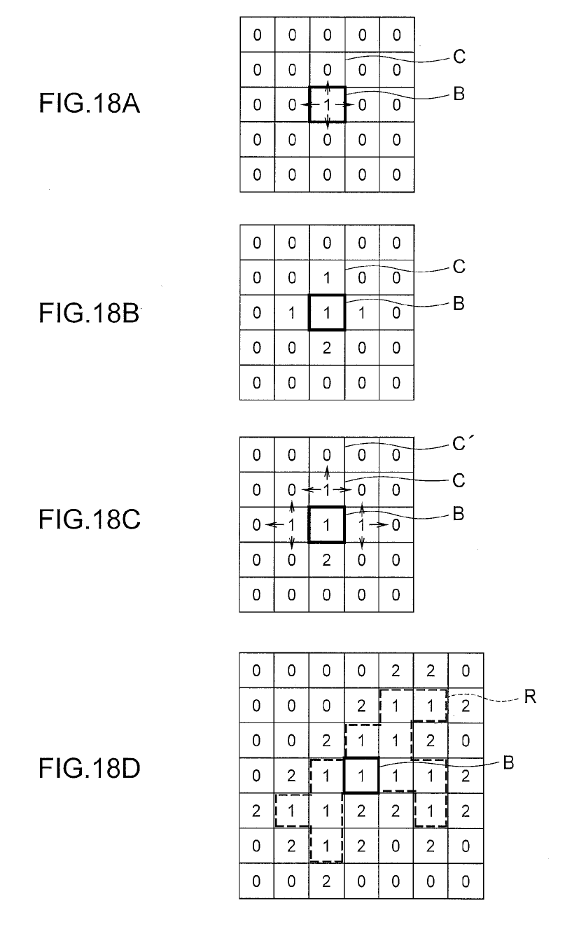

FIG. 17 is a flowchart illustrating details of step S14 of FIG. 4. FIGS. 18A to 18D, 19 and 20 are schematic diagrams for illustrating a process of FIG. 17.

In step S14, the reflection form factor g_{ionR} for treating the reflection of ionic species and the sputtering form factor g_{ionS} for treating the generation of neutral species due to sputtering using ionic species are calculated. The method of calculating these form factors g_{ionR} and g_{ionS} is substantially similar to the method of calculating the form factor “g” in FIG. 8, but is different from the method of calculating the form factor “g” in the following two points.

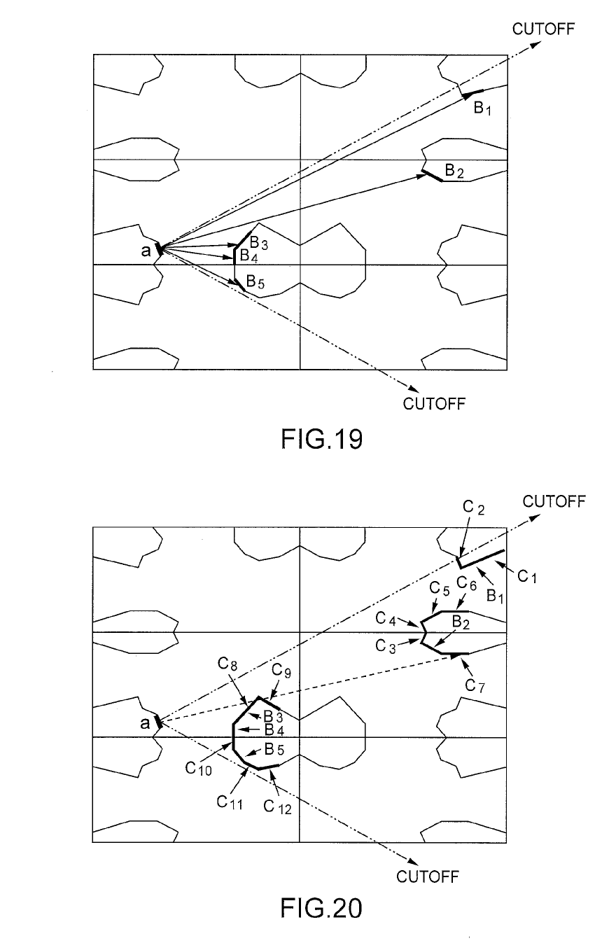

First, in the case of calculating the form factors g_{ionR} and g_{ionS}, cut-off for the directions in which the straight lines are extended is carried out in step S24 of FIG. 8 (see FIG. 19).

As described above with reference to FIGS. 6 and 7, the ionic species has high straightness and is not reflected in all directions. Therefore, when step S24 is carried out for calculating the reflection form factor g_{ionR}, the cut-off angle θ_{cut} for a reflection direction of the ionic species (see FIGS. 6 and 7) is set, and the directions in which the straight lines are extended are limited within the range of the cut-off angle θ_{cut}.

It is known that the generation of neutral species due to sputtering using ionic species exhibits a high anisotropy, as with the reflection of ionic species. Therefore, when step S24 is carried out for calculating the sputtering form factor g_{ionS}, a cut-off angle for a generation direction of the neutral species is set, and the directions in which the straight lines are extended are limited within the range of the cut-off angle, as in the case of the reflection form factor g_{ionR}.

The cut-off angle for the sputtering form factor g_{ionS} may be set to the same value as the cut-off angle for the reflection form factor g_{ionR}, or may be set to a value different from the cut-off angle for the reflection form factor g_{ionR}.

In FIG. 19, the directions in which the straight lines are extended from the computing element “a” are limited within the range of the cut-off angle. As a result, each of the computing elements B₁ to B₅ contacting the straight lines are positioned within the range of the cut-off angle. The directions in which the straight lines are extended may be limited to be equal to or smaller than the cut-off angle, or may be limited to be smaller than the cut-off angle.

The cut-off angle θ_{cut} can be defined in various manners. For example, it is assumed a case where an incident angle distribution of ionic species is defined as in the following formula (25).

Γ_{B,ion-direct}=f_{flat}Norm∫₀^{2π}∫₀^{π}η(θ_{local},φ_{local})cos^{N-1}θ_{local} cos θᵢₙ|sin θ_{local}|dθ_{local}dφ_{local} (25)

Note that the formula (25) is equal to a formula obtained by substituting the formula (17) into the formula (15).

In the case of using the formula (25), the cut-off angle θ_{cut} is desirably set such that directions θ_{local} and φ_{local} in which the value of the expression integrated in the formula (25) is decreased are cut off. In this case, since this expression depends on the computing element number (the number of computing elements) N, the cut-off angle θ_{cut} is also set to be dependent on the computing element number “N” as in the following formula (26).

θ_{cut}=f(N) (26)

In the formula (26), the cut-off angle θ_{cut} is a function of the computing element number “N”, and therefore depends on the computing element number “N”. In this case, the cut-off angle θ_{cut} varies depending on the computing element number “N” in such a manner that θ_{cut}=30 degrees when N=10, θ_{cut}=10 degrees when N=100, and θ_{cut}=3 degrees when N=1000, for example.

Second, when a straight line from the computing element “a” contacts the computing element “B” in the case of calculating the form factors g_{ionR} and g_{ionS}, the process of step S24 is also performed on the computing elements C and C′ surrounding the computing element “B” (see FIGS. 18 and 20). The computing element “C” is directly adjacent to the computing element “B”, and the computing element “C′” is indirectly adjacent to the computing element “B” through the computing element “C”. The computing element “a”, the computing element “B”, the computing elements “C” and “C′” are respectively examples of the first, second, and third computing elements of the disclosure.

Specifically, a new straight line is extended toward the computing element “C” which is directly adjacent to the computing element “B” from the computing element “a”, and it is judged whether this straight line contacts the computing element “C” without involving other computing elements. It is also judged whether the computing element “C” is positioned within the range of the cut-off angle θ_{cut} of the computing element “a”. In this way, the determination process of step S24 is also performed on the computing element “C”, as with the computing element “B”.

When the straight line from the computing element “a” contacts the computing element “C” and the computing element “C” is positioned within the range of the cut-off angle θ_{cut} of the computing element “a” (that is, when positive results of the judgments are obtained with respect to the computing element “C”), the process of step S24 is also performed on the computing element “C′” which is directly adjacent to the computing element “C”.

In this embodiment, such a process is repeated until there is no candidate for computing elements to be judged. Specifically, the method of this embodiment selects, as the third computing element, a computing element directly adjacent to the second computing element “B”, and a computing element indirectly adjacent to the second computing element “B” through one or more computing elements having positive results of the judgments, and the judgments are repeated until there is no candidate for the third computing element to be selected.

In FIG. 20, the process of step S24 is performed not only on the computing elements B₁ to B₅ illustrated in FIG. 19, but also on the computing elements C₁ to C₁₂. The straight lines from the computing element “a” contact the computing elements C₁ to C₅, C₈, C₁₀ and C₁₁. Among them, the computing element C₁ is positioned outside the range of the cut-off angle. The computing element C₁ is therefore excluded from the calculation of the form factors g_{ionR} and g_{ionS}. The computing elements C₆, C₇, C₉ and C₁₂ are located behind the other computing elements when viewed from the computing element “a”. Accordingly, the straight lines from the computing element “a” do not contact the computing elements C₆, C₇, C₉ and C₁₂. The computing elements C₆, C₇, C₉ and C₁₂ are therefore excluded from the calculation of the form factors g_{ionR} and g_{ionS}.

The process of FIG. 20 is carried out in the case of calculating the form factors g_{ionR} and g_{ionS}. Accordingly, even if the number of partitions (the number of straight lines to be extended) M×O in step S21 is set to be smaller than that in the calculation of the form factor “g”, a sufficient calculation accuracy can be obtained. Consequently, in this embodiment, the calculation time in step S24 for calculation of the form factors g_{ionR} and g_{ionS} can be reduced as compared with that for calculation of the form factor “g”. In this embodiment, in the case of calculating the form factors g_{ionR} and g_{ionS}, the determination process is performed not only on the computing element “B” by the process of FIG. 20, but also on the computing elements surrounding the computing element “B”, thereby enabling a more detailed determination process and a reduction in calculation errors.

FIGS. 17 and 18A to 18D illustrate the details of the process of FIG. 20. The process of FIG. 20 will be described in detail below with reference to FIGS. 17 and 18A to 18D. FIGS. 17 and 18A to 18D illustrate an example of executing the process illustrated in FIG. 20 by use of Seed Fill Algorithm.

In steps S31 to S33 of FIG. 17, straight lines are extended in a plurality of directions within the range of the cut-off angle from the computing element “a”, and it is determined which computing element the straight lines contact. That is, steps S31 to S33 respectively correspond to steps S21 to S24 in FIG. 8.

In step S33, it is determined whether the straight line from the computing element “a” contacts the computing element “B”. The state of this process is illustrated in FIG. 18A. Squares in FIG. 18A represent the computing element “B” and its surrounding computing elements. The numerical value in each square represents a flag set to each computing element.

A flag “θ” corresponds to an initial value. A computing element having a flag “1” indicates that the straight line from the computing element “a” contacts the computing element and the computing element is positioned within the range of the cut-off angle. A computing element having a flag “2” indicates that the straight line from the computing element “a” does not contact the computing element, or that the computing element is positioned outside the range of the cut-off angle.

When the straight line from the computing element “a” contacts the computing element “B”, the flag “1” is set to the computing element “B” (step S35). On the other hand, when the straight line from the computing element “a” does not contact the computing element “B”, the flag “2” is set to the computing element “B” (step S40). FIG. 18A illustrates the state in which the flag “1” is set to the computing element “B”.

In step S34, it is determined whether the computing element “B” is positioned within the range of the cut-off angle of the computing element “a”. However, in steps S31 to S32, straight lines are extended only in a direction within the range of the cut-off angle. Accordingly, the computing element “B” is positioned within the range of the cut-off angle in principle. This step S34 is important for a subsequent process in the case of cut-off determination on the computing elements surrounding the computing element “B”. Xₘₐₓ, Yₘₐₓ, Xₘᵢₙ, and Yₘᵢₙ illustrated in FIG. 17 respectively represent a maximum X coordinate, a maximum Y coordinate, a minimum X coordinate, and a minimum Y coordinate of the computing element “B”.

When the straight line from the computing element “a” contacts the computing element “B”, the process similar to that for the computing element “B” is performed on each computing element “C” directly adjacent to the computing element “B” as illustrated in FIG. 18A (steps S36 to S39).

Specifically, a new straight line is extended toward the computing element “C” from the computing element “a”, and it is determined (judged) whether this straight line contacts the computing element “C” (step S33). It is also determined (judged) whether the computing element “C” is positioned within the range of the cut-off angle of the computing element “a” (step S34).

When the straight line from the computing element “a” contacts a certain computing element “C” and the computing element “C” is positioned within the range of the cut-off angle, the flag “1” is set to the computing element “C” (step S35). On the other hand, when the straight line from the computing element “a” does not contact the computing element “C”, or the computing element “C” is positioned outside the range of the cut-off angle, the flag “2” is set to the computing element “C” (step S40). FIG. 18B illustrates the state in which the flag “1” or “2” is set to each computing element “C”.

When the flag “1” is set to a certain computing element “C′”, the process similar to that for the computing element “B” is performed on each computing element “C” which is directly adjacent to the computing element “C” (steps S36 to S39) as illustrated in FIG. 18C. However, this process is not required for the computing elements “C” to which the flag “1” or “2” has been already set.

In this embodiment, the processes of steps S36 to S39 are repeated until there is no candidate for computing elements to be determined (judged). Specifically, as illustrated in FIG. 18D, the processes of steps S36 to S39 are repeated until the computing elements having the flag “1” are surrounded by the computing elements having the flag “2”.

A symbol “R” in FIG. 18D denotes a region composed of computing elements having the flag “1”. In this embodiment, the computing elements included in this region “R” are counted as computing elements which contact the straight lines from the computing element “a” and are positioned within the range of the cut-off angle of the computing element “a”.

In this embodiment, a local coordinate system unique to each computing element is used in steps S12 to S14. Alternatively, a global coordinate system common to all computing elements may be used.

### (4) Calculation Time and Calculation Errors in First Embodiment

The calculation time and the calculation errors in the first embodiment will be described in consideration of the above description.

In the conventional method, it takes a time proportional to the number “N” of computing elements to calculate the direct fluxes Γ_{B,ne-direct} and Γ_{B,ion-direct} of any computing element “B”. This is because a loop calculation related to the computing element “B” is repeatedly performed N times. In the conventional method, it takes a time proportional to N² to calculate the visibility factor ν(a,B) and the form factors g(a,B), g_{ionR}(a,B), and g_{ionS}(a,B) between arbitrary computing elements “a” and “B”. This is because a loop calculation related to the computing element “a” and a loop calculation related to the computing element “B” are each repeatedly performed N times. The calculation time for the visibility factor and the form factor further increases when a mirror surface boundary condition and a periodic boundary condition are employed. Accordingly, most of the calculation time in the conventional method is used for calculation of the visibility factor and the form factor.

On the other hand, in this embodiment, as illustrated in FIGS. 8 and 17, straight lines are extended in a plurality of directions from each computing element “a”, it is determined whether each straight line contacts the substance surface and determined which computing element the straight lines contact, and a direct flux, a visibility factor, and a form factor are calculated based on the determination results. Accordingly, the visibility factor and the form factor are calculated by repeating the loop calculation related to the computing element “a” N times, as with the direct flux (see steps S22 and S30). Therefore, according to this embodiment, the calculation time for the direct flux, the visibility factor, and the form factor can be suppressed to a time proportional to the number “N” of computing elements.

In this embodiment, in the case of performing the determination process of step S24 for calculating the reflection form factor g_{ionR} and the sputtering form factor g_{ionS} in consideration of the difference in characteristics between ionic species and neutral species, a cut-off angle is set for the directions in which the ionic species is reflected and for the directions in which the neutral species is generated due to sputtering using ionic species, and the directions in which the straight lines are extended are limited within the range of the cut-off angle. Further, in this embodiment, the above-mentioned determination process is repeatedly applied to the computing elements surrounding the computing elements contacting these straight lines. Therefore, according to this embodiment, it is possible to reduce a waste of calculation to shorten the calculation time, and to reduce calculation errors by taking more time for useful calculation instead of useless calculation. When the generation of neutral species can be ignored, for example, when the amount of generated neutral species is small, the topography simulation may be performed while ignoring terms including the sputtering form factor g_{ionS} in the formula (4).

In the calculations of g, g_{ionR} and g_{ionS} this embodiment, the number of 0 elements in the g matrix, the g_{ionR} matrix, and the g_{ionS} matrix (as well as the ν matrix) tends to increase as compared with the conventional method of calculating g, g_{ionR} and g_{ionS} in the N²-times loop calculations. In this embodiment, straight lines are extended in a plurality of directions from each computing element, and it is determined whether each straight line contacts the substance surface and determined which computing element the straight lines contact to calculate the form factors. Consequently, in this embodiment, the probability that the form factors are 0 significantly increases as compared with the case where the loop calculation is performed between all the pairs of the computing elements, so that the ratio of 0 elements to all matrix elements of each of the g matrix, the g_{ionR} matrix, and the g_{ionS} matrix becomes ½ or more (more specifically, 0.8 or more in many cases). In this case, more than half of non-diagonal elements of the matrix Aₙₑ in the formula (13) become 0, and the matrix equation of the formula (10) becomes a simple form (similarly, more than half of non-diagonal elements of the matrix Aᵢₒₙ related to ionic species become 0, and the matrix equation including the matrix Aᵢₒₙ becomes a simple form). As a result, according to this embodiment, the calculation time and memory usage can be significantly reduced.

Accordingly, in the case of performing a chemical reaction calculation while repeatedly solving these matrix equations, this embodiment employs a calculation algorithm focusing on these 0 elements, thereby enabling a further reduction in the calculation time. Furthermore, the employment of a sparse matrix holding algorithm such as CRS enables memory saving as the number of 0 elements increases. In this case, the matrix equations are repeatedly solved until Sᵢ(Γᵢ), Rᵢ(Γᵢ), and Pᵢ(Γᵢ) are converged in step S17 of FIG. 4. In this calculation, since the calculation time for solving a matrix equation once is reduced due to its many 0 elements, the total calculation time in step S17 is significantly reduced.

### (5) Effects of First Embodiment

Effects of the first embodiment will be described.

As described above, in this embodiment, straight lines are extended in a plurality of directions from each computing element, it is determined whether each straight line contacts the substance surface and determined which computing element each straight line contacts, and the direct flux and the form factor are calculated based on the determination results. Further, the visibility factor is calculated based on the determination results.

Therefore, according to this embodiment, the calculation times for the direct flux and the form factor can be suppressed to time proportional to the number of computing elements. Therefore, according to this embodiment, the calculation time for the form factor that affects the calculation time for the indirect flux can be shortened, thereby enabling topography simulation to be performed high-speed in consideration of the reactive species directly or indirectly reaching the substance surface.

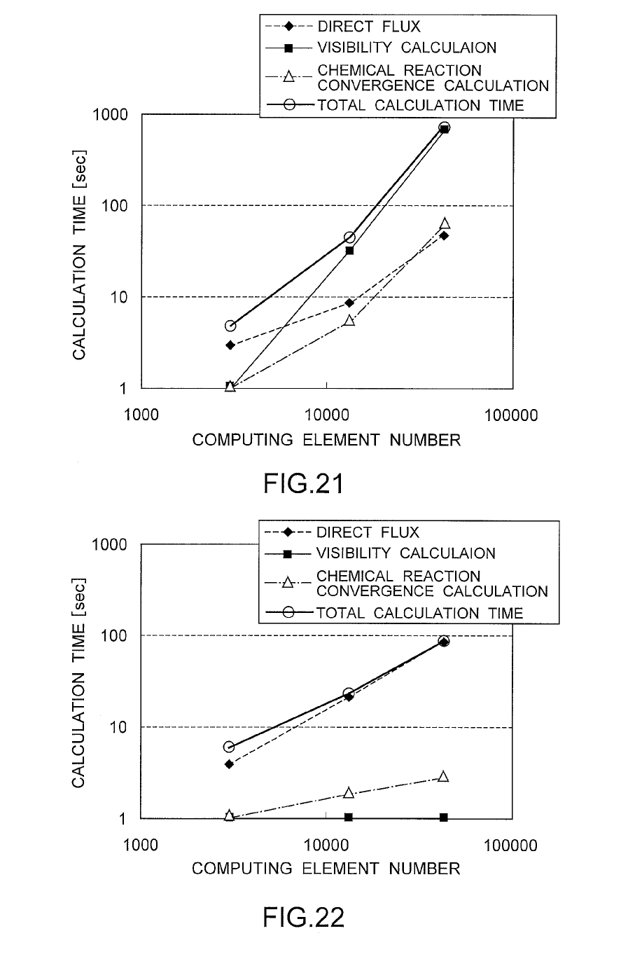

Specific examples of this effect will be described below with reference to FIGS. 21 to 24.

In this embodiment, in the case of performing the above-mentioned determination process for calculating the reflection form factor and the sputtering form factor in consideration of the difference in characteristics between ionic species and neutral species, a cut-off angle for a direction in which the ionic species is reflected and for a direction in which the neutral species is generated due to sputtering using ionic species is set, and the directions in which the straight lines are extended are limited within the range of the cut-off angle. Furthermore, the above-mentioned determination process is also repeatedly applied to the computing elements surrounding the computing element contacting these straight lines.

Therefore, according to this embodiment, it is possible to reduce a waste of calculation to shorten the calculation time, and to reduce calculation errors by taking more time for useful calculation instead of useless calculation, thereby enabling high-speed, high-precision topography simulation.

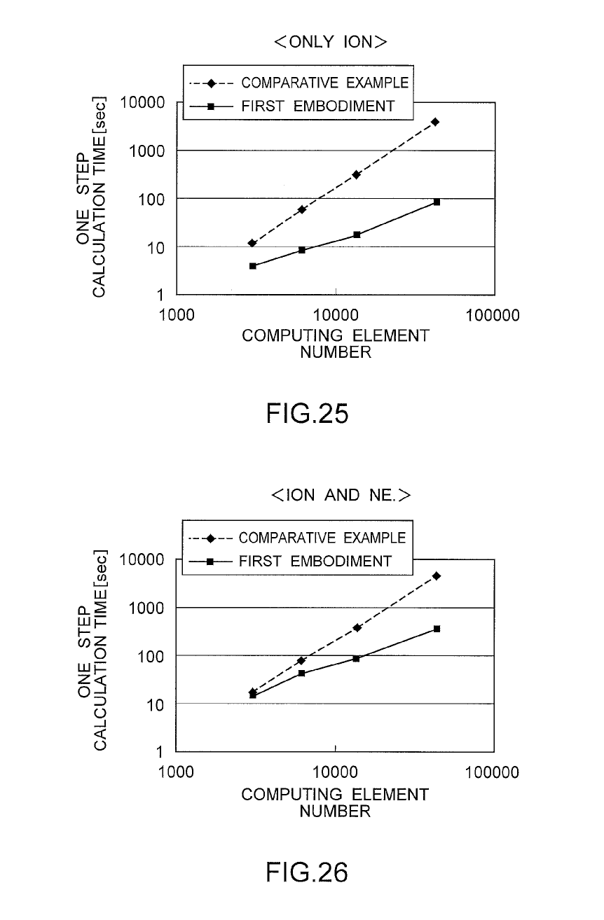

Specific examples of this effect will be described later with reference to FIGS. 25 to 28.

(5.1) Explanations of FIGS. 21 to 24

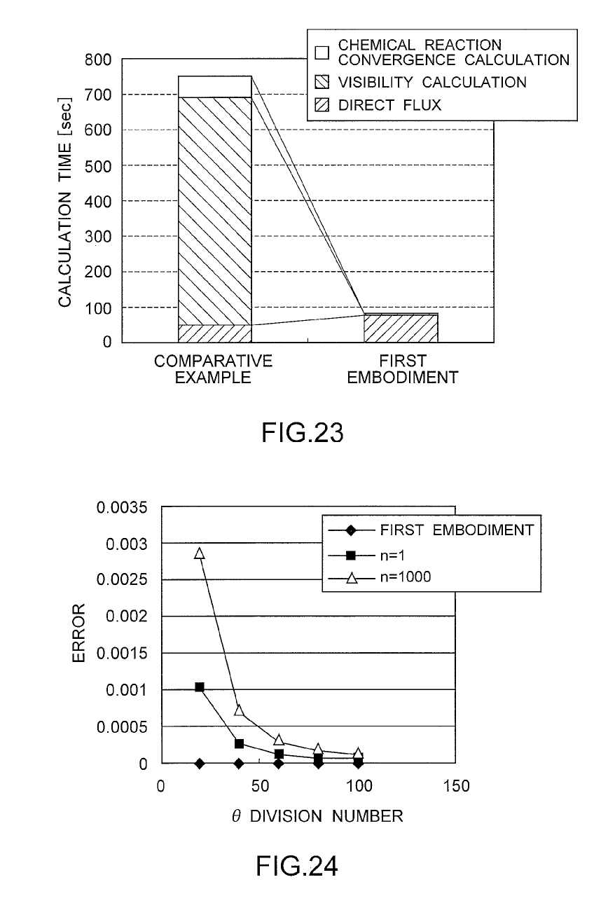

FIGS. 21 and 22 are graphs illustrating examples of the calculation time in a comparative example and the first embodiment, respectively. In FIGS. 21 and 22, calculation is carried out while ignoring the reflection form factor g_{ionR} and the sputtering form factor g_{ionS}, so as to verify the effect of the embodiment prior to setting the cut-off angle (also in FIGS. 23 and 24). In the comparative example, the direct flux, the visibility factor, and the form factor (g) are calculated using the conventional method. FIGS. 21 and 22 illustrate a calculation time for a direct flux, a calculation time for visibility calculation (calculation of a visibility factor and a form factor), a calculation time for a chemical reaction convergence calculation, and the sum of all calculation times, when the structure illustrated in FIG. 2 is used as an initial structure.

As illustrated in FIGS. 21 and 22, according to the first embodiment, the total calculation time can be reduced as compared with the comparative example. These comparison results are illustrated in FIG. 23. FIG. 23 is a graph illustrating a comparison between the calculation time of the first embodiment and the comparative example when the number of computing elements is 40000.

FIG. 24 is a graph illustrating a relation between a “θ” division number and the calculation errors in the first embodiment and the comparative example. Here, the local coordinate system is used for calculation illustrated in FIG. 24. The graphs of n=1 and n=1000 illustrate the calculation results of the comparative example. As illustrated in FIG. 24, the calculation errors can be further suppressed than the comparative example according to the first embodiment.

(5.2) Explanations of FIGS. 25 to 28

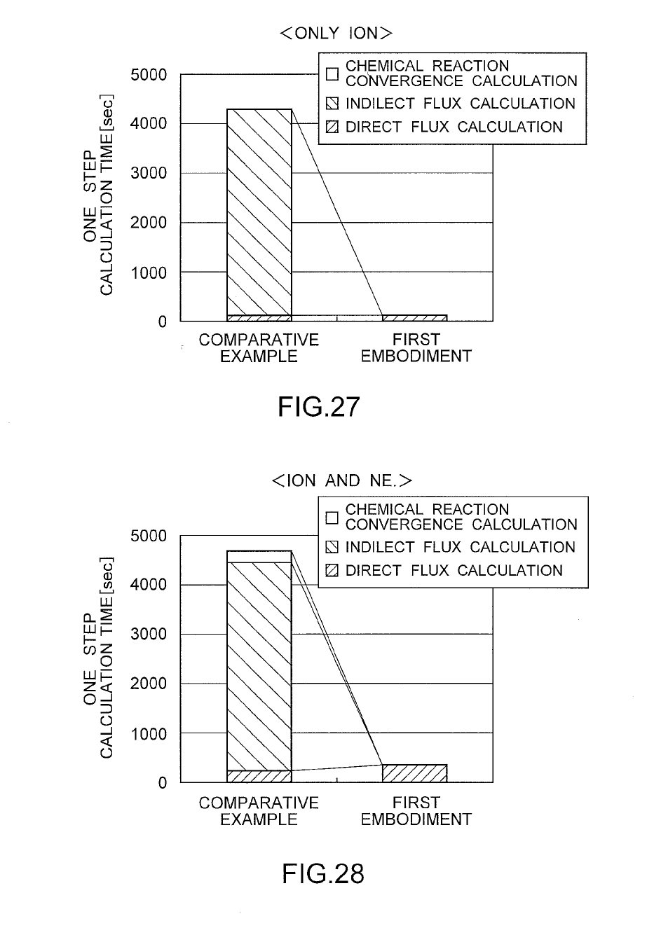

FIG. 25 is a graph illustrating a comparison between the calculation time of the first embodiment and the comparative example when only the ionic species is treated. FIG. 26 is a graph illustrating a comparison between the calculation time of the first embodiment and the comparative example when the ionic species and the neutral species are treated. One type of ions is treated in FIG. 25, and one type of ions and one type of neutral particles are treated in FIG. 26. In FIGS. 25 and 26, setting of a cut-off angle and the process of FIG. 18 are carried out in the first embodiment (also in FIGS. 27 and 28). FIGS. 25 and 26 illustrate total calculation times per step when the structure illustrated in FIG. 2 is used as an initial structure.

As illustrated in FIGS. 25 and 26, according to the first embodiment, the total calculation time can be further remarkably reduced than that of the comparative example as compared with the cases illustrated in FIGS. 21 and 22. The details of the comparison results are illustrated in FIGS. 27 and 28.

FIG. 27 is a graph illustrating a comparison between the calculation time of the first embodiment and the comparative example for each item when only the ionic species is treated, and corresponds to FIG. 25. FIG. 28 is a graph illustrating a comparison between the calculation time of the first embodiment and the comparative example for each item when the ionic species and the neutral species are treated, and corresponds to FIG. 26. The number of computing elements in FIGS. 27 and 28 is about 40000. In the examples illustrated in FIGS. 27 and 28, the calculation time for the indirect flux in the first embodiment can be remarkably reduced as compared with the comparative example.

The topography simulation method of the first embodiment may be executed using any information processing apparatus. In a second embodiment, a topography simulation apparatus will be described as an example of such an information processing apparatus.

### Second Embodiment

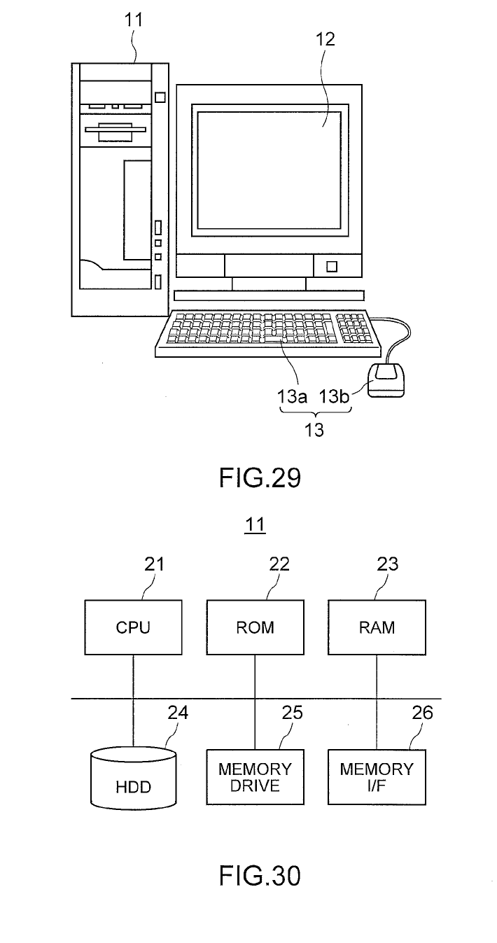

FIG. 29 is an outline view illustrating a configuration of a topography simulation apparatus of the second embodiment.

The topography simulation apparatus in FIG. 29 includes a control module 11, a display module 12, and an input module 13.

The control module 11 controls the operation of the topography simulation apparatus. The control module 11 executes the topography simulation method of the first embodiment, for example. The control module 11 will be described in detail later.

The display module 12 includes a display device such as a liquid crystal monitor. The display module 12 displays a configuration information input screen for the topography simulation, and a calculation result of topography simulation, for example.

The input module 13 includes input devices such as a keyboard 13a and a mouse 13b. The input module 13 is used for inputting configuration information for the topography simulation, for example. Examples of the configuration information include information on a calculation formula, information on an experimental value or a predicted value, information on the structure of the substance, information on a flux, and instruction information on the configurations and procedures for the topography simulation.

FIG. 30 is a block diagram illustrating a configuration of the control module 11 of FIG. 29.

The control module 11 includes a CPU (central processing unit) 21, a ROM (read only memory) 22, a RAM (random access memory) 23, an HDD (hard disk drive) 24, a memory drive 25 such as a CD (compact disc) drive, and a memory I/F (interface) 26 such as a memory port or a memory slot.

In this embodiment, a topography simulation program, which is a program for the topography simulation method of the first embodiment, is stored in the ROM 22 or the HDD 24. Upon receiving predetermined instruction information from the input module 13, the CPU 21 reads out the program from the ROM 22 or the HDD 24, develops the read program in the RAM 23, and executes the topography simulation by this program. Various data generated during this process are held in the RAM 23.

In this embodiment, a non-transitory computer-readable recording medium may contain the topography simulation program, and the topography simulation program may be installed from the recording medium into the ROM 22 or the HDD 24. Examples of the recording medium include a CD-ROM and a DVD-ROM (digital versatile disk ROM).

Further, in this embodiment, the topography simulation program can be downloaded via a network such as the Internet to be installed in the ROM 22 or the HDD 24.

As described above, according to this embodiment, it is possible to provide a topography simulation apparatus and a topography simulation program for executing the topography simulation method of the first embodiment.

In the first and second embodiments, a semiconductor device is adopted as an example of the object to which the topography simulation is applied, but the topography simulation can also be applied to devices other than the semiconductor device. Examples of such devices include a micro electro mechanical systems (MEMS) device and a display device.

While certain embodiments have been described, these embodiments have been presented by way of example only, and are not intended to limit the scope of the inventions. Indeed, the novel apparatuses, methods and media described herein may be embodied in a variety of other forms; furthermore, various omissions, substitutions and changes in the form of the apparatuses, methods and media described herein may be made without departing from the spirit of the inventions. The accompanying claims and their equivalents are intended to cover such forms or modifications as would fall within the scope and spirit of the inventions.

1. A topography simulation apparatus comprising:
a division module configured to divide a surface of a substance into a plurality of computing elements;
a determination module configured to extend straight lines in a plurality of directions from each computing element, and configured to determine whether each straight line contacts the surface of the substance and determine which computing element each straight line contacts; and
a calculation module configured to calculate, based on results of the determinations, a direct flux which is a flux of a reactive species directly reaching each computing element, and a form factor indicating a positional relationship between the computing elements,
wherein
when the determinations are performed to calculate the form factor in a case where an ionic species reaching each computing element is reflected, the determination module performs the determinations by setting a cut-off angle for a reflection direction of the ionic species, and limiting the directions in which the straight lines are extended within a range of the cut-off angle, and
when a straight line from a first computing element among the plurality of computing elements contacts a second computing element, the determination module judges whether a straight line from the first computing element contacts a third computing element surrounding the second computing element, and judges whether the third computing element is positioned within the range of the cut-off angle of the first computing element,
the determination module selecting, as the third computing element, a computing element directly adjacent to the second computing element, and a computing element indirectly adjacent to the second computing element through one or more computing elements each having positive results of the judgments, and repeating the judgments until there is no candidate for the third computing element to be selected.

2. The apparatus of claim 1, wherein when the determinations are performed to calculate the form factor in a case where a neutral species is generated by sputtering using the ionic species reaching each computing element, the determination module performs the determinations by setting a cut-off angle for a generation direction of the neutral species, and limiting the directions in which the straight lines are extended within a range of the cut-off angle.

3. The apparatus of claim 1, wherein when the determinations are performed to calculate the form factor in a case where a neutral species reaching each computing element is scattered from each computing element again, the determination module performs the determinations without performing cut-off for the directions in which the straight lines are extended.

4. The apparatus of claim 1, wherein the determination module sets the cut-off angle to be dependent on a number of the computing elements.

5. The apparatus of claim 1, wherein the calculation module calculates, by using the direct flux and the form factor, at least one of a total flux which is a flux of the reactive species directly or indirectly reaching each computing element, and a local surface growth rate of the substance.

6. The apparatus of claim 5, wherein
the calculation module calculates, based on the results of the determinations, a visibility factor indicating whether the computing elements are visible to each other, and
the calculation module calculates, by using the direct flux, the visibility factor and the form factor, at least one of the total flux and the surface growth rate.

7. The apparatus of claim 5, wherein the calculation module performs a time evolution on a level set function defined with a distance from the surface of the substance by using at least one of the total flux and the surface growth rate to calculate a change of topography of the substance.

8. The apparatus of claim 5, wherein the calculation module expresses the form factor by a form factor matrix in which half or more of matrix elements are zero, and solves a matrix equation including the matrix elements of the form factor matrix to calculate at least one of the total flux and the surface growth rate.

9. A topography simulation method comprising:
dividing a surface of a substance into a plurality of computing elements;
extending straight lines in a plurality of directions from each computing element, and determining whether each straight line contacts the surface of the substance and determining which computing element each straight line contacts; and
calculating, based on results of the determinations, a direct flux which is a flux of a reactive species directly reaching each computing element, and a form factor indicating a positional relationship between the computing elements,
wherein
when the determinations are performed to calculate the form factor in a case where an ionic species reaching each computing element is reflected, the determinations are performed by setting a cut-off angle for a reflection direction of the ionic species, and limiting the directions in which the straight lines are extended within a range of the cut-off angle, and
when a straight line from a first computing element among the plurality of computing elements contacts a second computing element, it is judged whether a straight line from the first computing element contacts a third computing element surrounding the second computing element, and judged whether the third computing element is positioned within the range of the cut-off angle of the first computing element,
the judgments comprising selecting, as the third computing element, a computing element directly adjacent to the second computing element, and a computing element indirectly adjacent to the second computing element through one or more computing elements each having positive results of the judgments, and the judgments being repeated until there is no candidate for the third computing element to be selected.

10. The method of claim 9, wherein when the determinations are performed to calculate the form factor in a case where a neutral species is generated by sputtering using the ionic species reaching each computing element, the determinations are performed by setting a cut-off angle for a generation direction of the neutral species, and limiting the directions in which the straight lines are extended within a range of the cut-off angle.

11. The method of claim 9, wherein when the determinations are performed to calculate the form factor in a case where a neutral species reaching each computing element is scattered from each computing element again, the determinations are performed without performing cut-off for the directions in which the straight lines are extended.

12. The method of claim 9, wherein the cut-off angle is set to be dependent on a number of the computing elements.

13. The method of claim 9, wherein further comprising calculating, by using the direct flux and the form factor, at least one of a total flux which is a flux of the reactive species directly or indirectly reaching each computing element, and a local surface growth rate of the substance.

14. The method of claim 13, wherein further comprising calculating, based on the results of the determinations, a visibility factor indicating whether the computing elements are visible to each other,
wherein at least one of the total flux and the surface growth rate is calculated by using the direct flux, the visibility factor and the form factor.

15. The method of claim 13, further comprising performing a time evolution on a level set function defined with a distance from the surface of the substance by using at least one of the total flux and the surface growth rate to calculate a change of topography of the substance.

16. The method of claim 13, further comprising expressing the form factor by a form factor matrix in which half or more of matrix elements are zero, and solving a matrix equation including the matrix elements of the form factor matrix to calculate at least one of the total flux and the surface growth rate.

17. A non-transitory computer-readable recording medium containing a topography simulation program which causes a computer to perform a topography simulation method, the method comprising:
dividing a surface of a substance into a plurality of computing elements;
extending straight lines in a plurality of directions from each computing element, and determining whether each straight line contacts the surface of the substance and determining which computing element each straight line contacts; and
calculating, based on results of the determinations, a direct flux which is a flux of a reactive species directly reaching each computing element, and a form factor indicating a positional relationship between the computing elements,
wherein
when the determinations are performed to calculate the form factor in a case where an ionic species reaching each computing element is reflected, the determinations are performed by setting a cut-off angle for a reflection direction of the ionic species, and limiting the directions in which the straight lines are extended within a range of the cut-off angle, and
when a straight line from a first computing element among the plurality of computing elements contacts a second computing element, it is judged whether a straight line from the first computing element contacts a third computing element surrounding the second computing element, and judged whether the third computing element is positioned within the range of the cut-off angle of the first computing element,
the judgments comprising selecting, as the third computing element, a computing element directly adjacent to the second computing element, and a computing element indirectly adjacent to the second computing element through one or more computing elements each having positive results of the judgments, and the judgments being repeated until there is no candidate for the third computing element to be selected.

18. The medium of claim 17, wherein when the determinations are performed to calculate the form factor in a case where a neutral species is generated by sputtering using the ionic species reaching each computing element, the determinations are performed by setting a cut-off angle for a generation direction of the neutral species, and limiting the directions in which the straight lines are extended within a range of the cut-off angle.

19. The medium of claim 17, wherein when the determinations are performed to calculate the form factor in a case where a neutral species reaching each computing element is scattered from each computing element again, the determinations are performed without performing cut-off for the directions in which the straight lines are extended.

20. The medium of claim 17, wherein the cut-off angle is set to be dependent on a number of the computing elements.
